(19) United States
(12) Patent Application Publication
(10) Pub. No.: US 2002/0153693 A1
(43) Pub. Date: Oct. 24, 2002

(54) Motorcycle and storage box arrangement thereof

(76) Inventor: Kousei Ohura, Hamamatsu-shi (JP)

Correspondence Address: NIXON & VANDERHYE P.C., 1100 North Glebe Rd., 8th Floor, Arlington, VA, 22201-4714, US

(21) Appl. No.: 10/058,137

(22) Filed: Jan. 29, 2002

(30) Foreign Application Priority Data
Apr. 24, 2001 (JP) 2001-126243
Jun. 14, 2001 (JP) 2001-180599

(51) Int. Cl. B62K 9/00

(52) U.S. Cl. 280/281.1; 280/288.4

(57) ABSTRACT

In a motorcycle including: a seat which can be opened upward and closed, a storage box disposed under the seat for holding helmets, the surround of the storage box being enclosed by a cover, the seat is comprised of a seat bottom plate, a seat cushion and a seat cloth. The seat bottom plate is integrally formed with a seat bottom plate extension which is extensionally formed along the outer periphery and projected downwards from the outer periphery, spreading outwardly toward its distal side. A sealing element is disposed between the storage box and the seat bottom plate extension and a cover is arranged so as to externally enclose the upper part of the storage box and the seat bottom plate extension. Further, in the sectional configuration cut across the vehicle's width, the storage box is shaped so that it spreads outwardly as it extends downwards from the opening edge of the upper opening, along the body cover which encloses the outer vehicle body below the seat while part of the opening edge of the upper opening on a first side with respect to the body width is shaped in a bay-like form so as to be sunken lower than the height of the opening edge on the opposite side.

### BACKGROUND OF THE INVENTION

(1) Field of the Invention

The present invention relates to a motorcycle and its storage box arrangement, in particular, relating to a motorcycle configuration with a storage box provided under the seat.

(2) Description of the Prior Art

Some recent motorcycles have been known to have a storage box which is arranged under an openable seat to accommodate helmets, attachecases and the like.

With concern to motorcycles of this kind, Japanese Utility Model Application Laid-Open Sho 64 No.37787 discloses a configuration in which the opening of the storage box is sealed by the seat bottom plate. However, in this arrangement, the storage box needs to have a greater breadth than the content size and the seat arranged over the opening of the storage box stretches out sidewards, so that this configuration has the drawback of hindering the rider or extra rider from riding on and getting off, or degrading easiness in straddling and resting the feet.

To deal with the above drawback, Japanese Patent Application Laid-Open Hei 1 No.202589 discloses a configuration in which a cover spreading outwards is provided around the periphery of the seat bottom plate so as to reduce the breadth of the seat body. There is also another proposal disclosed in Japanese Utility Model Publication Hei 8 No.10550, in which an appendage component and cover which spread outwards are arranged around the periphery of the seat bottom plate so as to reduce the breadth of the seat body.

However, since the arrangement of Japanese Patent Application Laid-Open Hei 1 No.202589 is so configured that the sealing element abuts at an inner position with respect to the fixture of the cover to the seat bottom plate, the size of the opening of the storage box across vehicle's width cannot help becoming smaller than the spread of the cover, thus posing a problem of the opening of the storage box being narrow.

Further, according to Japanese Patent Application Laid-Open Hei 1 No.202589, the extension plate provided around the outer periphery of the seat bottom plate serves as a cover element for covering the abutment between the storage box and the seat bottom plate, and the opening brim of the storage box is configured to abut against the peripheral edge of the seat. Therefore, the opening brim of the storage box cannot be made wider than the rim of the seat and hence the shape of the opening is restricted by the shape of the seat.

According to Japanese Utility Model Publication Hei 8 No.10550, since the seal element is adapted to abut at an outer position with respect to the fixture of the appendage component to the seat bottom plate, it is possible to secure a wide enough size of the opening of the storage box across vehicle's width. However, since the appendage component is needed separately, this results in increase in cost.

It is apparent that if the sealing surface of the seat bottom plate, on which the sealing element abuts, is structured with a complex curved surface, the dimensional accuracy of the sealing surface will affect the sealability. In both the configurations disclosed in Japanese Patent Application Laid-Open Hei 1 No.202589 and Japanese Utility Model Publication Hei 8 No.10550, the sealing surface is defined by a part separated from the seat bottom plate, so that the sealing surface has less dimensional accuracy compared to the case where the sealing surface is formed by the bottom plate itself. Accordingly, the sealability has not always been perfectly assured.

When the configurations disclosed in Japanese Patent Application Laid-Open Hei 1 No.202589 and Japanese Utility Model Publication Hei 8 No.10550, where the extension plate or appendage component which is separated from the seat bottom plate is arranged at the outer periphery of the seat bottom plate so as to abut the opening brim of the storage box formed under the seat against the extension plate or appendage component, are applied to a motorcycle having a dual seat, or seats for rider and extra rider arranged front and back, with a storage box under either the rider's seat or extra rider's seat only, the extension plate or appendage component cannot be laid out around the rider's seat. Therefore, some parts are needed to directly abut the sheet bottom plate, and this makes the sealing surface discontinuous, causing imperfection in sealability.

Further, according to the configurations disclosed in Japanese Patent Application Laid-Open Hei 1 No.202589 and Japanese Utility Model Publication Hei 8 No.10550, since the opening of the storage box is located at a height lower than the lower end of the seat, the storage box depth becomes less. If many pieces of small items such as golf balls need to be stored into a storage space defined by a receptacle or storage box with a lesser depth and a lid formed of a seat bottom having a large depth, such items can be piled only as high as the height of the opening of the storage box, being unable to utilize the storage space inside the seat bottom, hence the actual volume capable of being used is far less than the nominal capacity of the storage space.

Further, when the motorcycle is parked on the kickstand, the storage box as well as the body becomes inclined to the side of the kickstand. Therefore, the height of the opening of the storage box on the kickstand side is further lowered so that the amount of storage for small items is further reduced.

### SUMMARY OF THE INVENTION

The present invention has been devised in view of the above configuration problems and it is therefore an object of the present invention to provide a low-cost motorcycle and its storage box arrangement, which can markedly enlarge the opening size and the volume of the storage box without increasing the seat width, improve the storage capacity of small items such as golf balls, etc. when it is parked on the kickstand, and assure a high sealability of the opening.

In order to achieve the above object, the present invention is configured as follows:

In accordance with the first aspect of the present invention, a motorcycle comprises: a seat which can be opened upward and closed; a storage box whose upper opening is opened and closed by the seat and which is able to hold helmets, the surround of the storage box is covered by the body cover, and is characterized in that

the seat is comprised of a seat bottom plate, a seat cushion for covering the top of the seat bottom plate and a seat cloth for covering the surface of the seat cushion;

the seat bottom plate is integrally formed with a seat bottom plate extension which is extensionally formed along the outer periphery, spreading outwardly toward its distal side;

a sealing element is disposed between the upper opening brim of the storage box and the seat bottom plate extension; and

a cover is arranged over the outer peripheral surface of the seat bottom plate extension so as to externally enclose the upper part of the storage box having the sealing element disposed thereon and the seat bottom plate extension.

In accordance with the second aspect of the present invention, the motorcycle having the above first feature is characterized in that the seat is integrally formed with a rib-like structure, projected outwards from the seat bottom plate and disposed along the outer periphery of the seat cushion around the seat bottom plate extension and the rib-like structure together with the seat cushion is covered by the seat cloth with the distal part of the seat cloth fixed by fasteners.

In accordance with the third aspect of the present invention, the motorcycle having the above first feature is characterized in that the storage box has a volume capable of storing at least two helmets and is shaped into a storage compartment which can keep the two helmets placed side by side across the vehicle's width with their spherical tops set laterally outward with respect to the body width, their lower sides abutted to each other, and their front set forwards with respect to the vehicle's direction of travel and has an inner shape congruent with the outer shapes of the helmets thus arranged.

In accordance with the fourth aspect of the present invention, the motorcycle having the above second feature is characterized in that the storage box has a volume capable of storing at least two helmets and is shaped into a storage compartment which can keep the two helmets placed side by side across the vehicle's width with their spherical tops set laterally outward with respect to the body width, their lower sides abutted to each other, and their front set forwards with respect to the vehicle's direction of travel and has an inner shape congruent with the outer shapes of the helmets thus arranged.

In accordance with the fifth aspect of the present invention, the motorcycle having the above first feature is characterized in that the storage box is constructed in such a manner that the bottom surface is formed to be lower at both sides than at the center across the body width so that two helmets can be held side by side across the body width with their spherical tops inclined downwards and laterally outward with respect to the body width.

In accordance with the sixth aspect of the present invention, the motorcycle having the above second feature is characterized in that the storage box is constructed in such a manner that the bottom surface is formed to be lower at both sides than at the center across the body width so that two helmets can be held side by side across the body width with their spherical tops inclined downwards and laterally outward with respect to the body width.

In accordance with the seventh aspect of the present invention, the motorcycle having the above third feature is characterized in that the storage box is constructed in such a manner that the bottom surface is formed to be lower at both sides than at the center across the body width so that two helmets can be held side by side across the body width with their spherical tops inclined downwards and laterally outward with respect to the body width.

In accordance with the eighth aspect of the present invention, the motorcycle having the above fourth feature is characterized in that the storage box is constructed in such a manner that the bottom surface is formed to be lower at both sides than at the center across the body width so that two helmets can be held side by side across the body width with their spherical tops inclined downwards and laterally outward with respect to the body width.

In accordance with the ninth aspect of the present invention, a storage box arrangement for use in a motorcycle includes: a seat which can be opened upward and closed; a storage box whose upper opening is opened and closed by the seat and which is able to hold helmets, the surround of the storage box is enclosed by the body cover, and is characterized in that, in the sectional configuration cut across the vehicle's width, the storage box is shaped so that it spreads outwardly as it extends downwards from the opening edge of the upper opening, along the body cover which encloses the outer vehicle body below the seat while part of the opening edge of the upper opening on a first side with respect to the body width is shaped in a bay-like form so as to be sunken lower than the height of the opening edge on the opposite side.

In accordance with the tenth aspect of the present invention, the storage box arrangement for use in a motorcycle having the above ninth feature is characterized in that the storage box is constructed so that the distance from the approximate center of the luggage compartment to the opening edge on the first side is greater than the distance to the opening edge on the opposite side and the opening edge on the first side with respect to the vehicle width is positioned so that the opening width is approximately equal to the maximum width of the luggage storing compartment.

In accordance with the eleventh aspect of the present invention, the storage box arrangement for use in a motorcycle having the above ninth feature is characterized in that the storage box is constructed so that the opening edge on the first side is formed on the side opposite to a kickstand which is arranged on one side with respect to vehicle's width.

In accordance with the twelfth aspect of the present invention, the storage box arrangement for use in a motorcycle having the above tenth feature is characterized in that the storage box is constructed so that the opening edge on the first side is formed on the side opposite to a kickstand which is arranged on one side with respect to vehicle's width.

In accordance with the thirteenth aspect of the present invention, the storage box arrangement for use in a motorcycle having the above eleventh feature is characterized in that the storage box is constructed so that the opening edges on both sides are adapted to be set approximately horizontal when the motorcycle is parked in a position tilted to one side with the kickstand set down.

In accordance with the fourteenth aspect of the present invention, the storage box arrangement for use in a motorcycle having the above twelfth feature is characterized in that the storage box is constructed so that the opening edges on both sides are adapted to be set approximately horizontal when the motorcycle is parked in a position tilted to one side with the kickstand set down.

In accordance with the fifteenth aspect of the present invention, the storage box arrangement for use in a motorcycle having the above ninth feature is characterized in that the seat comprises a seat bottom plate having a side wall which is extensionally formed at sides with respect to the vehicle's width, spreading outwardly as it extends downwards, and the storage box is constructed such that the opening edge on the first side with respect to the vehicle's width is adapted to abut the bottom wall of the seat bottom plate and abut the lower end of the seat bottom plate side-wall while the opening edge on the other side is made to abut the bottom wall of the seat bottom plate.

In accordance with the sixteenth aspect of the present invention, the storage box arrangement for use in a motorcycle having the above tenth feature is characterized in that the seat which can be opened upward and closed comprises a seat bottom plate having a side wall which is extensionally formed at sides with respect to the vehicle's width, spreading outwardly as it extends downwards, and the storage box is constructed such that the opening edge on the first side with respect to the vehicle's width is adapted to abut the bottom wall of the seat bottom plate and abut the lower end of the seat bottom plate side-wall while the opening edge on the other side is made to abut the bottom wall of the seat bottom plate.

According to thus configured present invention, the following effects are achieved.

Illustratively, in a scooter type motorcycle having a storage box capable of storing helmets and small items under the openable seat, the seat bottom plate is formed integrally with a seat bottom plate extension which is extensionally formed along the outer periphery and projected from the outer periphery, spreading outwardly toward its distal side while a sealing element is disposed between the upper opening brim of the storage box and the seat bottom plate extension. This configuration makes possible provision of the sealing surface outside the seat bottom plate side wall and makes it possible to design the opening of the storage box provided under the seat without any restriction of the outline of the seat. Further, it is possible to provide an opening wider than that of the conventional storage box even if the seat is small in width, and it is also possible to provide a storage box which has a large storage volume and makes it easy to put things in and take them out. In one word, this configuration provides easiness in straddling while securing the volume of the storage box.

Since the seat bottom plate extension which abuts the opening brim of the storage box to establish sealing is integrally extended from the seat bottom plate and the sealing surface corresponding to the whole opening brim of the storage box as well as the seat bottom plate extension is integrally extended as the abutment from the seat bottom plate and formed continuously, this makes it possible to improve the dimensional accuracy and it easy to secure the necessary sealability even if the sealing surface is defined by a complex curved surface. Accordingly, this configuration is effective in preventing dirt, rain water and the like from entering the storage box.

Further, if the seat flanking side is large in height, stylishness may be lost in outline design. According to the arrangement of the present invention, since the cover is provided so as to enclose the upper part of storage box having sealing element disposed thereon and seat bottom plate extension, from the outer side, it is possible to reduce the height of the portion below the apparent seat end compared to the conventional configuration, hence enhance the outline design flexibility.

Since the seat is configured so that a rib structure projected outward from the seat bottom plate is integrally formed along the outer periphery of the seat cushion near the seat bottom plate extension, it is possible to prevent the seat bottom plate from warping due to the tension of the seat cloth and hence prevent appearance deformation. Further, the fixing configuration of the seat cloth end to the rib structure makes the seat cloth small.

Arrangement of at least a pair of helmets to the rear side in storage box, with their spherical tops set laterally outward with respect to the vehicle, their lower sides abutted to each other and their front set forwards, makes it possible to prevent the portion of the storage box at its maximum width from interfering with the seat position of the rider or extra rider.

Forming the bottom of the storing compartment of the storage box to be lower at both sides than at the center across the body width and placement of two helmets side by side across the body width with their spherical tops inclined downwards and laterally outward with respect to the body width, makes it possible to reduce the width of the storing compartment compared to the configuration where the helmets are put flat, hence narrower the vehicle body.

Further, since helmets are placed in an inclined manner so that they can be snugly fitted to a lower position along the inclined surface in the storing compartment, it is possible to prevent helmets and other stored things from being shaken casually inside the storing compartment due to impacts from the road surface and the vehicle body being banked during riding. Further, since the storage box is laid out over the rear wheel, the storing compartment can be arranged at a lower position avoiding the rotational locus of the rear wheel. Therefore, it is possible to reduce the height of the seat arranged thereabove.

Further, the storage box arrangement of a motorcycle is shaped such that, in the sectional configuration cut across the vehicle's width, it spreads outwardly as it extends downwards from the opening edge of the upper opening, along the body cover which encloses the outer vehicle body below the seat. That is, the luggage storing compartment is formed so that its middle or lower part with respect to the height is wider than its upper part and part of the opening edge of the upper opening, on a first side with respect to the body width is shaped in a bay-like form so as to be sunken lower than the height of the opening edge on the opposite side. This arrangement contributes to improvement in easiness in riding on and getting off the seat arranged thereover and also provides a large opening width, which makes it easy to put things in and take them out.

Further, the upper opening is formed so that the distance from the approximate center of the storage box to the opening edge on a first side with respect to the vehicle's width is greater than the distance to the opening edge on the other side and the opening edge on the first side is positioned so that the opening width is approximately equal to the maximum width of luggage storing compartment. This arrangement makes it easier to put things in and take them out.

Further, by arranging the opening edge on the first side, on the side opposite to the kickstand provided on the other side of the vehicle, it is possible to increase the effective depth of the luggage storing compartment when the motorcycle is inclined to the kickstand side with the kickstand set down or in the state where luggage is loaded.

Moreover, since the opening is formed so that the opening edges of the luggage storing compartment are adapted to be set approximately horizontal when the motorcycle is parked in a position tilted to one side with the kickstand set down, the effective depth of the luggage storing compartment is gained when the motorcycle is parked on the kickstand.

Finally, the seat comprises a seat bottom plate having a side wall which is extensionally formed at sides with respect to the vehicle's width, spreading outwardly as it extends downwards. The storage box is constructed such that the opening edge on one side with respect to the vehicle's width is adapted to abut the bottom wall of the seat bottom plate and abut the lower end of the seat bottom plate side-wall while the opening edge on the other side is made to abut the bottom wall of the seat bottom plate. This arrangement makes it possible to secure a large difference in height between the left and right opening edges and deal with the large tilt angle of the motorcycle when it is parked on the kickstand.

### BRIEF DESCRIPTION OF THE DRAWINGS

FIG. 1 is a side view showing the overall configuration of a scooter type motorcycle according to the embodiment of the present invention;

FIG. 2 is a see-through side view showing the arrangement of the seat and storage box of the scooter type motorcycle;

FIG. 3 is a plan view showing the overall configuration of the scooter type motorcycle;

FIG. 4A is a sectional view cut along an A-A plane in FIG. 2, showing the seat structure of the scooter type motorcycle and FIG. 4B is a detailed view of a portion encircled by D;

FIG. 5 is a sectional view cut along a B-B plane in FIG. 2, showing the same seat structure;

FIG. 6 is a sectional view cut along a C-C plane in FIG. 2, showing the same seat structure;

FIG. 7 is a detailed sectional view showing the configuration of variational example 1 of the first embodiment;

FIG. 8 is a detailed sectional view showing the configuration of variational example 2 of the first embodiment;

FIG. 9 is a detailed sectional view showing the configuration of a conventional seat structure;

FIG. 10 is a sectional view cut along an A-A plane in FIG. 2, in accordance with the second embodiment;

FIG. 11 is a detailed partial view showing a portion encircled by E in FIG. 10;

FIG. 12 is a detailed partial view showing a portion encircled by F in FIG. 10;

FIG. 13A is an illustrative view showing the method of putting a first helmet into the storage box in accordance with the second embodiment and FIG. 13B is an illustrative view showing the method of putting a second helmet into the storage box;

FIG. 14 is an illustrative view showing the stored state of small items in the storage box when the scooter type motorcycle of the second embodiment is parked on the kickstand; and

FIG. 15 is an illustrative view showing the stored state of small items in a conventional storage box.

### DESCRIPTION OF THE PREFERRED EMBODIMENTS

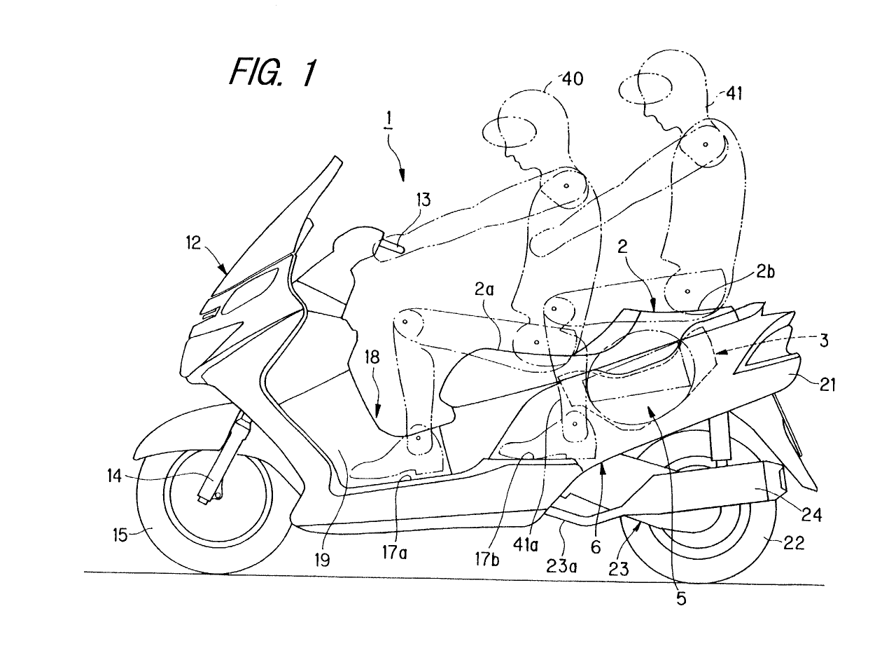

The embodiments of the present invention will hereinafter be described in detail with reference to the accompanying drawings. FIGS. 1 to 3 are drawings common to the first and second embodiments of the present invention.

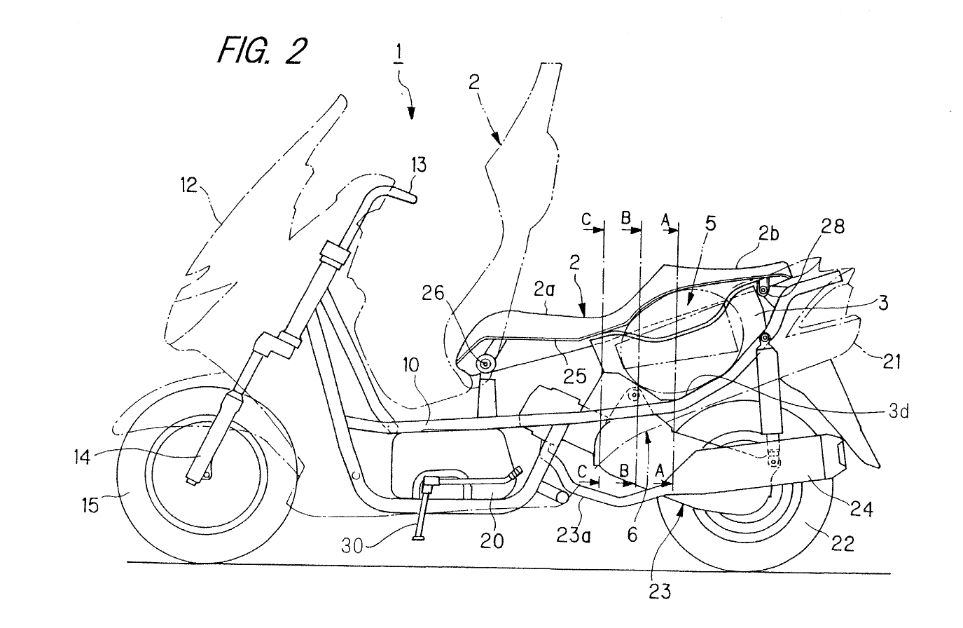

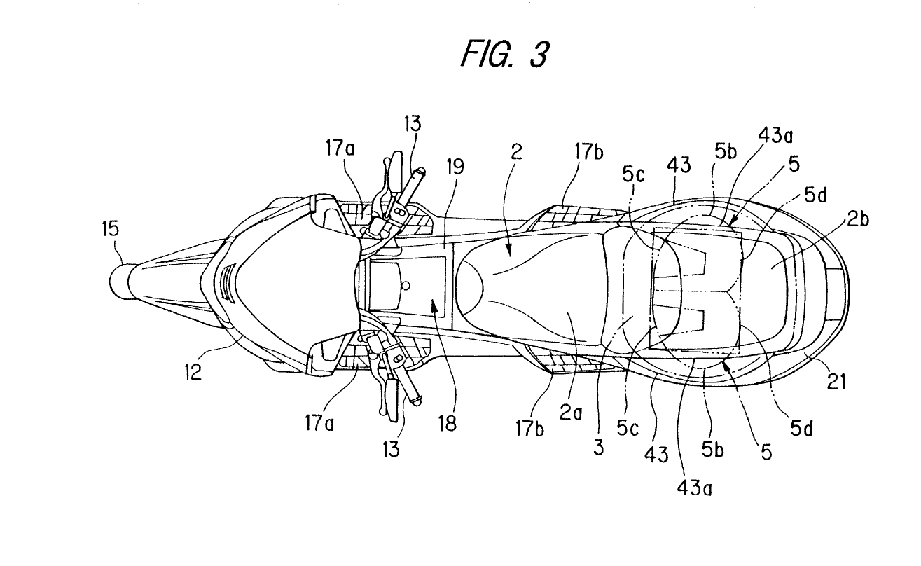

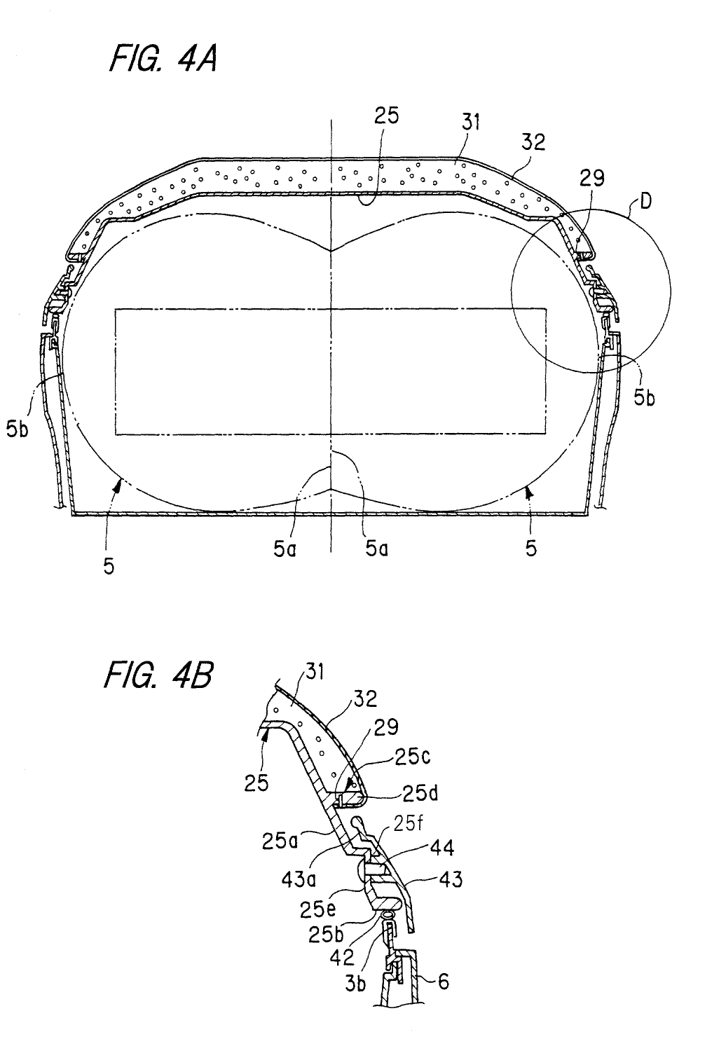

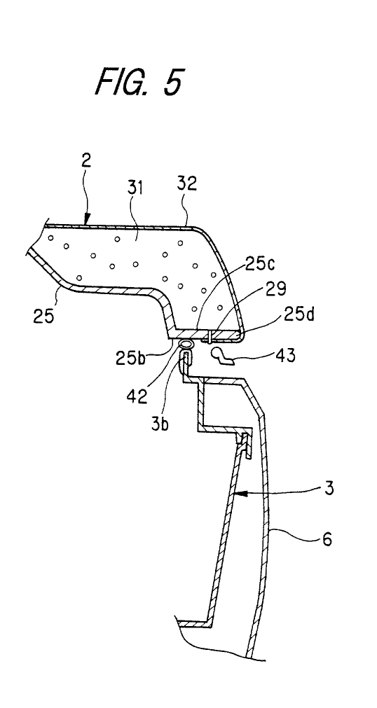

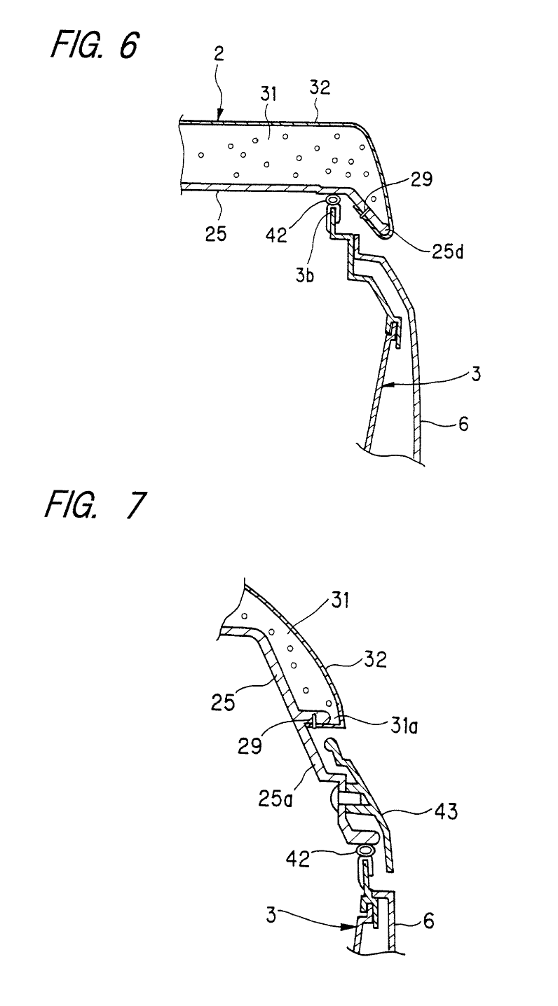

FIGS. 1 to 6 shows the first embodiment of the present invention. FIG. 1 is a side view showing the configuration of a scooter type motorcycle according to the embodiment of the present invention. FIG. 2 is a see-through side view showing the arrangement of the seat and storage box of the scooter type motorcycle. FIG. 3 is a plan view showing the overall configuration of the scooter type motorcycle. FIG. 4A is a sectional view cut along an A-A plane in FIG. 2, showing the seat structure of the scooter type motorcycle in the first embodiment of the present invention. FIG. 4B is a detailed view of a portion encircled by D. FIG. 5 is a sectional view cut along a B-B plane in FIG. 2, showing the same seat structure. FIG. 6 is a sectional view cut along a C-C plane in FIG. 2, showing the same seat structure. In the drawings, like reference numerals designate like items.

This embodiment is a large-sized scooter type motorcycle 1 for two riders, as shown in FIGS. 1 and 2, comprising a seat 2 that rotates upward to open itself and a storage box 3 serving as luggage storing compartment, whose upper opening 3a is opened by the seat 2 so as to be able to hold helmets 5 therein, and which is enclosed by a body cover 6.

As shown in FIGS. 1 and 3, in a body front 12, a pair of handlebars 13 are supported by a frame 10 while a front fork 14 which rotatably supports a front wheel 15 is arranged below and coupled with the handle bars 13. A seat 2 is arranged in the rear of the body front 12. Formed between this body front 12 and seat 2 is a floor portion 19, which is composed of a pair of plate-like footboards 17a arranged on the left and right with respect to the motorcycle's direction of travel for allowing the front rider 40 riding astride the seat 2 to rest their feet thereon and a center console 18 which rises, forming a ridge between these foot boards 17a. Provided behind the footboards 17a are a pair of footboards 17b for an extra rider 14, at a higher position than that of footboards 17a.

As shown in FIG. 2, a fuel tank 20 is arranged under floor portion 19 while a kickstand 30 is pivotally attached at the left side with respect to the vehicle's front so that the stand can be kept at the supporting and retracted positions. Further, a rear cover 21 is provided to enclose the rear part of the vehicle while a rear wheel 22 is disposed under the cover and supported by a unit-swing type engine 23 so that the wheel can move up and down.

The aforementioned unit-swing type engine 23 has a four-cycle engine mounted thereon. An exhaust passage 23a coupled to the exhaust port (not shown) of the engine is extended to the rear along the engine and its rear end is coupled to a muffler 24 around rear wheel 22 below rear cover 21.

Next, the structure of the seat will be described in detail.

Seat 2 is a dual type composed of a main seat 2A at the approximate center of the vehicle and an extra seat 2b formed in its rear at a higher position, as shown in FIGS. 1 and 2. As shown in FIG. 3, the sides of the seat from the rear of main seat 2A to extra seat 2b are formed approximately parallel when viewed from top. Under the main seat 2A and extra seat 2b a resin-made seat bottom plate 25 is provided extending from the front end of the main seat 2A to the rear end of the extra seat 2b.

A storage box 3 is formed on the bodywork under the extra seat 2b while the seat 2 serves as its lid.

The portion of seat bottom plate 25 opposing storage box 3 is configured as shown in FIG. 2 in a concave form with respect to the seat interior so that, when helmets 5 are stored in storage box 3, the seat bottom plate covers the bulge of helmets 5 beyond the storage box 3 along the outline of the helmets 5.

As shown in FIG. 2, seat 2 is pivotally supported on the bodywork by a seat hinge 26 formed at the lower front end of main seat 2A so that it can swing up and down and is fixed to the vehicle body by engagement of a seat lock 28 formed at the lower rear end of extra seat 2b. In seat 2 a seat cushion 31 is provided on the top of seat bottom plate 25 and a seat cloth 32 is covered over the cushion 31 with its lower end fixed to seat bottom plate 25 with staples 29, as shown in FIG. 4A.

As is shown in FIGS. 4A and 4B, seat bottom plate 25 integrally has a seat bottom plate extension 25a which is extensionally formed along the outer periphery and projected from the outer periphery, spreading outwardly toward its distal side. A sealing element 42 is disposed between an upper opening brim 3b of the storage box 3 and the seat bottom plate extension 25a. Further, a cover 43 is fixed to the outer peripheral surface of seat bottom plate extension 25a so as to externally enclose the upper part of storage box 3 having the sealing element 42 disposed thereon and the seat bottom plate extension 25a.

This cover 43 is so formed as seen in FIG. 3 that the bordering sides 43a along the outer shape of seat 2 are made straight and approximately parallel when viewed from top and the covering surface becomes curved, swelling sidewards from the body as it extends downwards.

Storage box 3 holds a pair of helmets 5 therein as shown in FIGS. 3 and 4, with their lower sides (fitted sides) 5a and 5a abutted to each other, their spherical tops 5b and 5b set laterally outward with respect to the body width and their front 5c set forwards. That is, storage box 3 has a curved shape such that, as shown in FIG. 3, it maximally swells sidewards of the vehicle, at the portions, in its approximate center when viewed from top with respect to the front-to-rear direction, and opposing the tops 5b of helmets 5.

The extra rider 41 riding astride above the storage box 3 is seated with their ankles 41a positioned at the front side of helmets 5.

In general, a helmet has a more compact outline at the helmet front 5c than at the helmet rear 5d. Therefore, the arrangement of a pair of helmets 5 being accommodated in the aforementioned manner makes it possible to narrow the body width or the straddled width between ankles 41a of extra rider 41, hence enhancing the comfort when extra rider 41 is riding astride, compared to the case where a pair of helmets 5 are accommodated with their lower sides 5a and 5a abutted to each other and their front 5c set rearwards.

The sealing geometry of storage box 3 gradually varies forward and rearward along the brim of storage box, from the central position cut on the A-A plane in FIG. 2 to the position cut on the C-C plane by way of the position cut on the B-B plane.

Referring to FIGS. 4A and 4B to FIG. 6, when seat 2 is fully closed, the whole part of the sealing surface, designated at 25b, is abutted against sealing element 42 attached to upper opening brim 3b of storage box 3, so as to keep the interior of storage box 3 sealed.

The lower fringe of seat 2 is so shaped that on the A-A section in the approximate center of storage box 3, a rib 25c is integrally formed, extending in the lateral direction, on the side wall of seat bottom plate 25, as shown in FIG. 4B while seat cloth 32 is disposed so as to cover the rib 25c along its side and bottom. On the B-B section at which seat bottom plate 25 shown in FIG. 2 varies in shape, sealing surface 25b and seat bottom plate end 25d become flush with each other as shown in FIG. 5 while seat cloth 32 is disposed so as to cover seat bottom plate end 25d along its side and bottom. Further, On the C-C section at around the front end of storage box 3 in FIG. 2, shown in FIG. 6, seat bottom plate end 25d extends inclined outward and downwards to a position lower than sealing element 42 while seat cloth 32 is formed so as to cover the end portion.

As shown in FIG. 4B, at the approximate center at the side of storage box 3, a passage hole 25f is formed inward of the vehicle body through the seat bottom plate side-wall, designated at 25e, between seat bottom plate end 25d and sealing surface 25b so that cover 43 is fixed to the side wall by a screw 44 fastened into the hole 25f. This cover 43 is placed over the portion lower than seat bottom plate end 25d, in the A-A section when viewed from side, forming the outline in combination with body cover 6 when the seat is closed.

Next, storage of helmets 5 into storage box 3 according to the first embodiment will be described with reference to the drawings.

When helmets 5 are put into storage box 3, the rear end of seat 2 is lifted up first so that it is rotated forwards about seat hinge 26 provided at the front end, as shown in FIG. 2 and the upper opening 3a of storage box 3 formed under seat 2 is exposed.

Then, as shown in FIG. 3 and FIG. 4A, the helmets are put in storage box 3 with their lower parts 5a abutted to each other, placed side by side across the vehicle's width and their front 5c set forwards and slightly inclined downwards. In this state, seat 2 is rotated down and seat lock 28 is set into engagement with the sealing surface on the seat 2 side and sealing element 42 on the storage box 3 side put into hermetic contact with each other. Thus, storage of helmets 5 is completed.

As has been configured, according to the scooter type motorcycle 1 of the first embodiment, since seat bottom plate extension 25a is integrally formed with seat bottom plate 25 of seat 2 while seat element 42 is provided between upper opening brim 3b of storage box 3 and sheet bottom plate extension 25a, sealing surface 25b can be arranged to be formed outside the seat bottom plate side wall. As a result, it is possible to design upper opening 3a of storage box 3 provided under seat 2 without any restriction of the outline of seat 2.

Further, according to the first embodiment, since seat bottom plate extension 25a is formed so as to be extensionally formed along the outer periphery and projected from the outer periphery, spreading outwardly toward its distal side, it is possible to secure an opening wider than that of the conventional storage box even if seat 2 is small in width. Thereby, it is possible to provide a storage box 3 which has a large storage volume and makes it easy to put things in and take them out.

According to the first embodiment, since sealing surface 25b as well as the seat bottom plate extension 25a is integrally and continuously formed from seat bottom plate 25, it is possible to improve the dimensional accuracy when parts are manufactured. Therefore, it is easy to secure the necessary sealability even if sealing surface 25b is defined by a complex curved surface, hence this configuration is effective in preventing dirt, rain water and the like from entering the storage box.

According to the first embodiment, since storage box 3 has such a curved shape that it maximally swells sidewards of the vehicle, at the portions, in its approximate center when viewed from top with respect to the vehicle's direction of travel, and opposing the tops 5b of helmets 5 and that extra rider 41 riding astride above the storage box 3 is seated with their ankles 41a positioned at the front side of helmets 5, it is possible to secure the easiness in straddling and yet assure the necessary volume of the storage box.

According to the first embodiment, since cover 43 is provided so as to externally enclose the upper part of storage box 3 having sealing element 42 disposed thereon and seat bottom plate extension 25a, it is possible to reduce the height of the portion below the apparent seat end compared to the conventional configuration, hence enhance the outline design flexibility.

According to the first embodiment, since rib 25c projected outward from seat bottom plate 25 is integrally formed, it is possible to prevent the seat bottom plate from warping due to the tension of seat cloth 32 and hence prevent appearance deformation. Further, the fixing configuration of the seat cloth end to rib 25c makes seat cloth 32 small.

According to the first embodiment, since a pair of full-face type helmets 5 are placed to the rear side in storage box 3, with their spherical tops 5b set laterally outward with respect to the vehicle body, their lower sides 5a abutted to each other and their front 5c set forwards, it is possible to prevent the part of storage box 3 at its maximum width from interfering with the seat position of the rider or extra rider.

According to the first embodiment, since helmets 5 are placed in storage box 3 so that they are inclined forwards and downwards with respect to the body, their lower portions can be snugly fitted along the inclined side walls of storage box 3. Therefore, it is possible to prevent helmets 5 and other stored things from being shaken casually inside storage box 3 due to impacts from the road surface and the body being banked during travelling. Further, since storage box 3 is laid out over rear wheel 22, the storage box 3 can be arranged at a lower position, avoiding the rotational locus of rear wheel 2. Therefore, it is possible to reduce the height of seat 2 arranged thereabove.

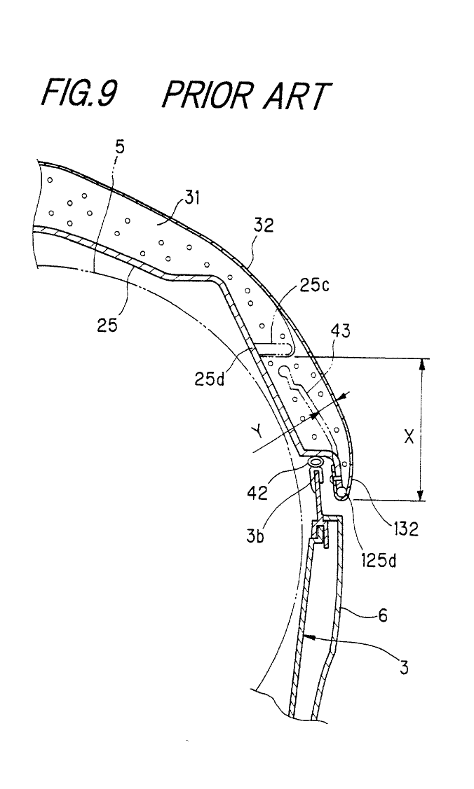

Referring now to FIG. 9, comparison between the seat structure of the first embodiment with the conventional seat structure will be made. In this figure, reference numerals 125d and 132 designate the conventional seat bottom plate end and the conventional seat cloth, respectively. The sheet bottom plate end 25d of the first embodiment can be formed smaller and shorter in height by X compared to the conventional sheet bottom plate end 125d. Further, cover 43 of the first embodiment can be formed narrower in width by Y compared to the position of the conventional seat cloth 132.

Next, variational examples of the first embodiment will be shown.

The sealing structure according to the first variational example of the scooter type motorcycle of the present invention is arranged as shown in FIG. 7 so that, in the A-A section shown in FIG. 2, a seat cushion end 31a is additionally formed on the outer side of rib 25c which extends in the lateral direction along the sheet bottom plate side wall and is integrally formed with sheet bottom plate 25 and externally covered by seat cloth 32. This configuration makes it possible to design the outer shape of seat cloth 32 freely, without any restriction of the shape of rib 25c.

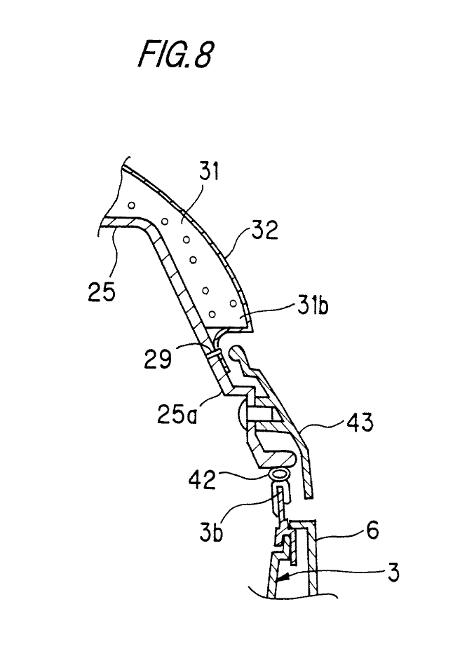

Next, the sealing structure according the second variational example of the scooter type motorcycle of the present invention is arranged as shown in FIG. 8 so that, in the A-A section shown in FIG. 2, a seat cushion end 31b is formed in the lateral direction on the sheet bottom plate side wall and externally covered by seat cloth 32. This configuration makes it possible to design the outer shape of seat cloth 32 freely since no rib 25c exists.

In the first embodiment, a pair of helmets 5 are arranged flat, side by side across the body width in the storage box. However, the present invention should not be limited to this. For example, the bottom of the storage box may be formed to be lower at both sides than at the center across the body width, so that two helmets are put side by side across the body width with their spherical tops inclined downwards and laterally outward with respect to the body width. This arrangement makes it possible to further reduce the width of the storage box compared to the configuration where the helmets are put flat, hence narrower the vehicle body.

Next, the second embodiment of the present invention will be described in detail with reference to the drawings. As mentioned already, FIGS. 1 to 3 are drawings common to the first and second embodiments of the present invention.

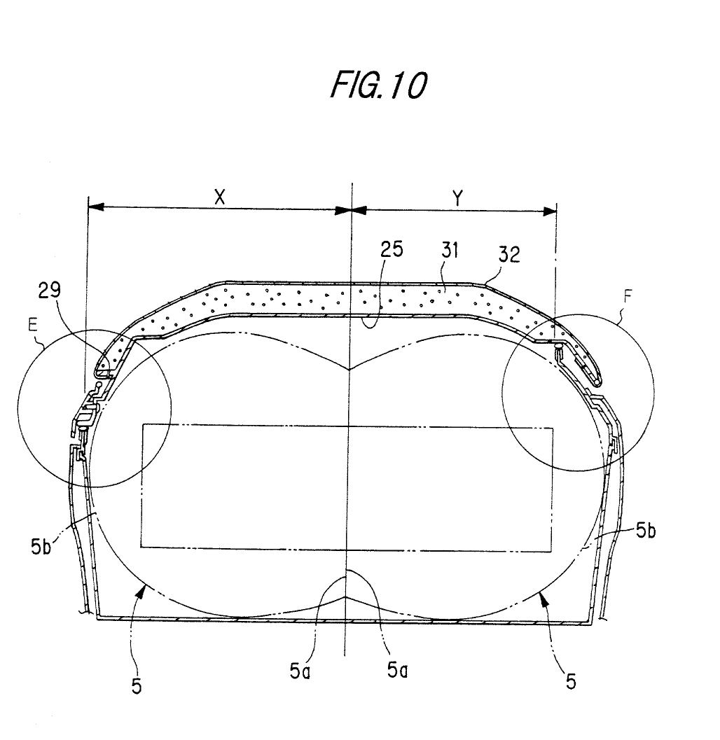

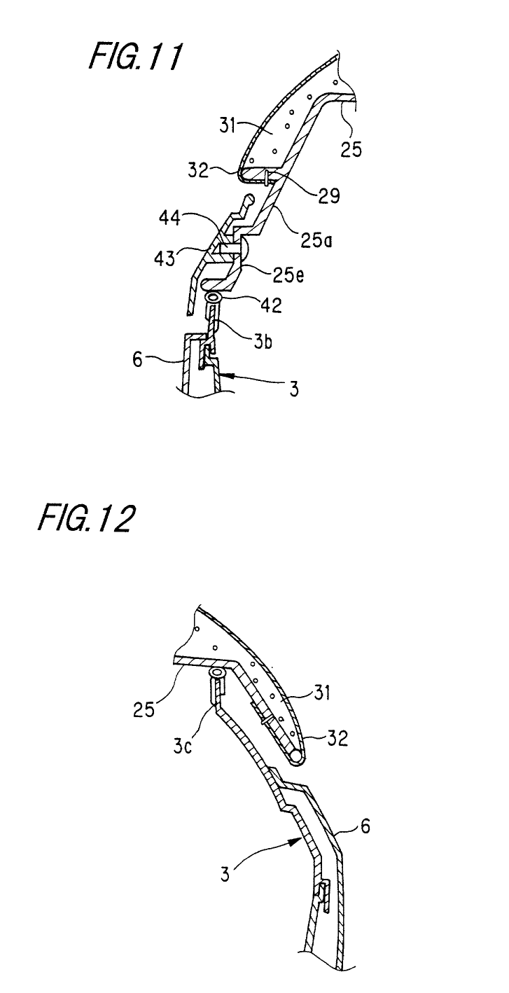

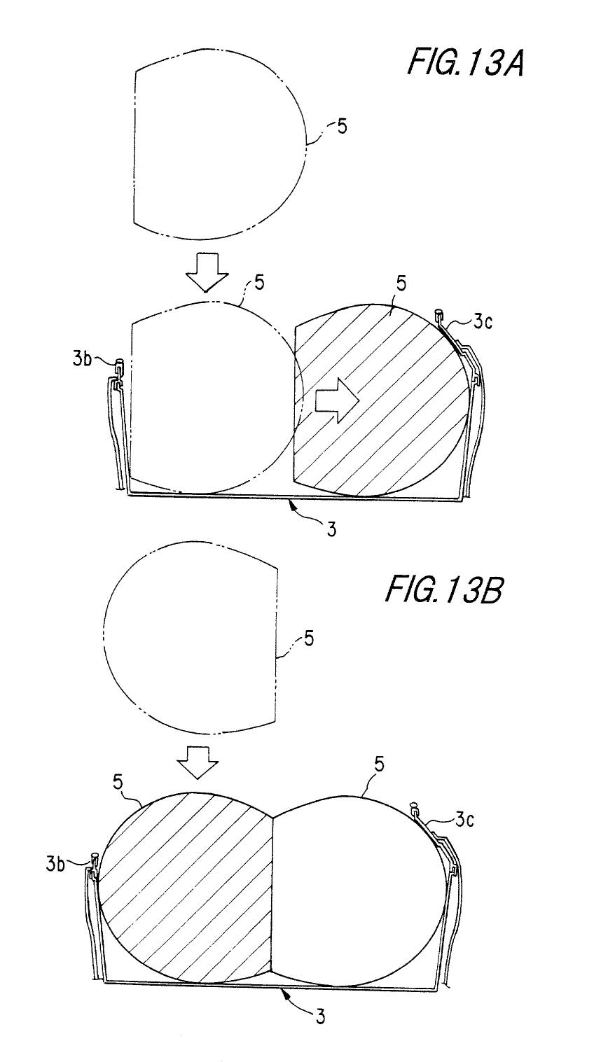

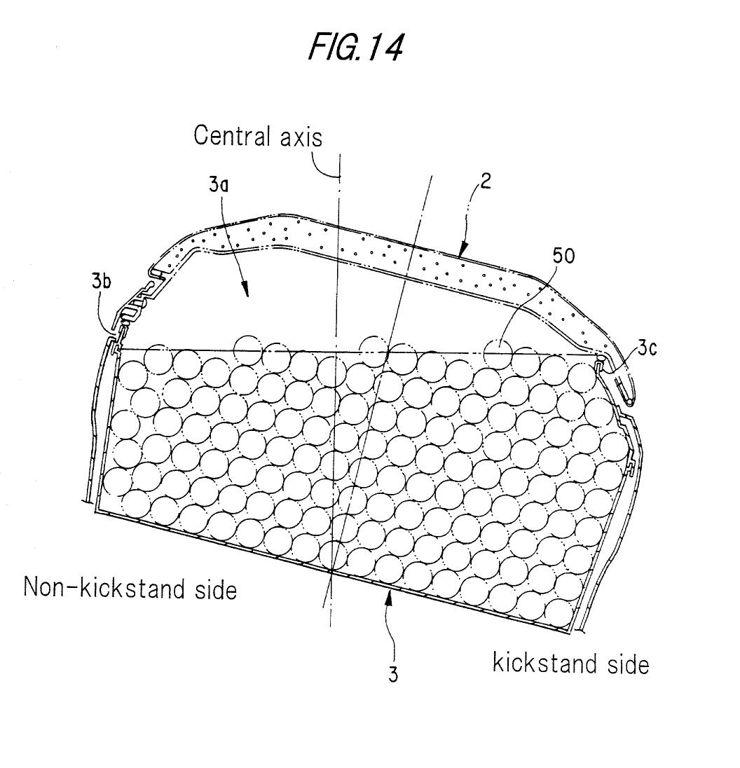

In the second embodiment, FIG. 10 is a sectional view cut along an A-A plane in FIG. 2. FIG. 11 is a detailed view showing a portion encircled by E in FIG. 10. FIG. 12 is a detailed view showing a portion encircled by F in FIG. 10. FIG. 13A is an illustrative view showing the method of putting a first helmet into the storage box in accordance with the second embodiment and FIG. 13B is an illustrative view showing the method of putting a second helmet into the storage box. FIG. 14 is an illustrative showing the stored state of small items in the storage box when the scooter type motorcycle of the second embodiment is parked on the kickstand. In the drawings, like reference numerals designate like items.

To begin with, as shown in FIG. 11, seat bottom plate 25 on one side with respect to the body width, integrally has a seat bottom plate extension 25a as a side wall which is extensionally formed along the outer periphery and projected from the outer periphery, spreading outwardly toward its distal side. An opening edge 3b of upper opening 3a of the storage box 3 and the end of the seat bottom plate extension 25a, which opposes the opening edge 3b are made to abut each other with a sealing element 42 in between. Further, as shown in FIG. 3, a cover 43 is fixed to the outer peripheral surface of the seat bottom plate extension 25a so as to externally enclose the upper part of storage box 3 having the sealing element 42 disposed thereon and the seat bottom plate extension 25a.

Seat bottom plate 25 on the other side with respect to the body width is configured as shown in FIG. 12 in such manner that an opening edge 3c of upper opening 3a of the storage box 3 and the specified position of seat bottom plate 25 opposing the opening edge 3c are made to abut each other with sealing element 42 in between. Further, a sheet bottom plate end 25d is extended outward and downwards in an inclined shape to a position lower than the sealing element 42 so as to externally cover the abutment with the aforementioned opening edge 3c.

Referring to FIGS. 11 and 12, when seat 2 is fully closed, sheet bottom plate 25 and the sealing surface, designated at 25b, are abutted against sealing element 42 attached to upper opening edges 3b and 3c i.e., the whole upper opening brim 3a of storage box 3, so as to keep the interior of storage box 3 sealed.

Next, the arrangement of storage box 3 as a luggage storing compartment will be described in detail.

Storage box 3 is to hold a pair of helmets 5 therein as shown in FIGS. 3 and 10, with their lower sides (fitted sides) 5a and 5a abutted to each other, their spherical tops 5b and 5b set laterally outward with respect to the body width and their front 5c set forwards. That is, storage box 3 has such a curved shape, as shown in FIG. 3, that it maximally swells sidewards of the vehicle, at the portions, in its approximate center when viewed from top with respect to the vehicle's front-to-rear direction, and opposing the tops 5b of helmets 5. Further, as shown in FIG. 2, upper opening 3a of storage box 3 is formed so that its front side is lower than its rear side with respect to the vehicle's direction of travel, the bottom, designated at 3d, is so formed that the front bottom is deeper than the rear bottom, whereby the helmets 5 stored in storage box 3 are put with its front side 5c inclined forward and downwards.

This storage box 3 is arranged as follows. That is, as shown in FIGS. 10 and 12, in the sectional configuration cut across the vehicle's width, the side wall on one side with respect to the vehicle's width is constructed so that it extends outwardly wider downwards from opening edge 3c of upper opening 3a, along a body cover 6 which encloses the outer vehicle body below the seat 2 while, as shown in FIG. 2, FIG. 10 and FIG. 11, part of opening edge 3b of upper opening 3a on the other side with respect to the body width is shaped in a bay-like form so as to be sunken lower than the height of the opening edge 3c on the opposite side.

Upper opening 3a of storage box 3 is formed so that the distance X from the central axis to opening edge 3b on a first side with respect to the vehicle's width is greater than the distance Y to the opening edge 3c on the other side and the opening edge 3b is positioned to be approximately equal to the maximum width of storage box 3 from the central axis. The opening edge 3b is formed on the side opposite to kickstand 30 provided on one side with respect to the vehicle's width.

Further, the storage box 3 is formed so that the opening edges 3b and 3c are adapted to be set approximately horizontal when the motorcycle is parked in a position tilted to one side with respect to the vehicle's width with kickstand 30 set down as shown in FIG. 14.

The apparent lower end of seat 2 is so shaped that on the A-A section in the approximate center of storage box 3 in FIG. 2, a rib 25c is integrally formed with the seat bottom plate at a position opposing to the opening edge of upper opening 3a on the first side, extending in the lateral direction, on the seat bottom plate side wall, as shown in FIG. 11 while seat cloth 32 is formed so as to cover the rib 25c along its side and bottom.

On the other hand, at the portion opposing the opening edge of upper opening 3a on the other side, seat bottom plate end 25d extends inclined outward and downwards to a position lower than sealing element 42 while seat cloth 32 is formed so as to cover the end portion.

As shown in FIG. 11, at the approximate center at the side of storage box 3, a passage hole 25f is formed inward of the vehicle body through the seat bottom plate side-wall, designated at 25e, between seat bottom plate end 25d and sealing surface 25b so that cover 43 is fixed to the side wall by a screw 44 fastened into the hole 25f. This cover 43 is placed over the portion lower than seat bottom plate end 25d, in the A-A section when viewed from side, forming the outline in combination with body cover 6 when the seat is closed.

Next, storage of helmets 5 into storage box 3 according to the second embodiment will be described with reference to the drawings.

When helmets 5 are put into storage box 3, the rear end of seat 2 is lifted up first so that it is rotated forwards about seat hinge 26 provided at the front end, as shown in FIG. 2 and the upper opening 3a of storage box 3 formed under seat 2 is exposed.

Then, as shown in FIG. 13A, a first helmet 5 is put into storage box 3 from upper opening 3a in such a manner that its front 5c is set forward with respect to the vehicle's direction of travel and slightly inclined downwards while top 5b is set to the side and close to the inner wall on one side with respect to the vehicle's width in storage box 3.

When a second helmet 5 is put into storage box 3, as shown in FIG. 13B, the lower ends 5a of the first and second helmets are abutted to each other so that the two helmets are placed side by side across the vehicle's width and their front 5c set forwards and slightly inclined downwards. In this state, seat 2 is rotated down and seat lock 28 is set into engagement with sealing surface 25b on the seat 2 side and sealing element 42 on the storage box 3 side put into hermetic contact with each other. Thus, storage of two helmets 5 is completed.

Next, storage of small items into storage box 3 according to the second embodiment will be described with reference to the drawings.

Storage of stuff into storage box 3 is usually performed when the vehicle is parked. In the second embodiment, small items such as golf balls are put into storage box 3 when scooter type motorcycle 1 is parked on kickstand 30.

When scooter type motorcycle 1 is rest on kickstand 30, the body is set tilted to the kickstand 30 side. As the scooter type motorcycle 1 tilts so too, to the same degree towards the kickstand side, does storage box 3 under seat 2, as shown in FIG. 14.

Since storage box 3 is formed so that opening edge 3b of upper opening 3a on the non-kickstand side is formed to be lower by the predetermined amount than opening edge 3c on the kickstand side, upper opening 3a is set approximately horizontally as shown in FIG. 14 when scooter type motorcycle 1 is parked.

When small items 50 are put into storage box 3, the rear end of seat 2 is lifted up so that it is rotated forwards about seat hinge 26 provided at the front end, as shown in FIG. 2 and the upper opening 3a of storage box 3 formed under seat 2 is exposed. Then small items 50 are put therein.

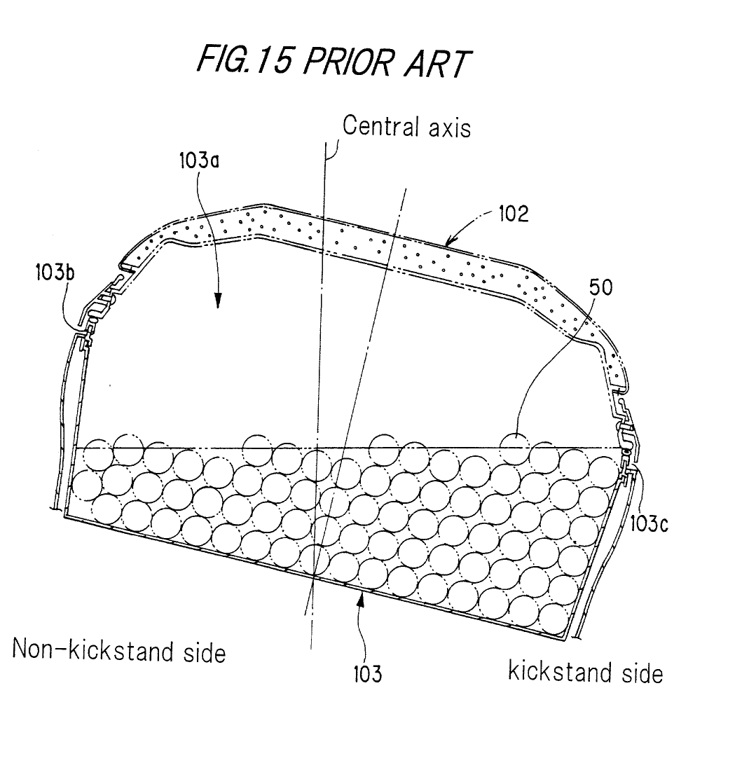

Here, FIG. 15 shows a conventional example where opening edges 103b and 103c at both sides of an upper opening 103a are formed at the same level. According to the conventional configuration of opening edges 103b and 103c of upper opening 103a, when storage box 103 is inclined, opening edge 103c on the kickstand side is positioned at a significantly lower level than opening edge 103b on the non-kickstand side. Therefore, the effective depth of the stored portion of storage box 103 is shallow so the stored amount greatly decreases. In contrast to this, according to the configuration of upper opening 3a of the present embodiment, as shown in FIG. 14, since opening edge 3c on the kickstand side is formed higher than opening edge 3b on the non-kickstand side, the opening edge 3b on the non-kickstand side is positioned at a higher level when storage box 3 is tilted. Thus, small items 50 can be put in under this condition, a greater amount of items than usual can be stored.

As described heretofore, according to the second embodiment, storage box 3 has such a curved shape that it maximally swells sidewards of the vehicle, at the portions, in its approximate center when viewed from top with respect to the vehicle's front-to-rear direction, and opposing the tops 5b of helmets 5, wherein two helmets 5 are placed with their lower sides (fitted sides) 5a and 5a abutted to each other, their spherical tops 5b and 5b set laterally outward with respect to the body width and their front 5c set forwards. Further, upper opening 3a is formed so that its front side is lower than its rear side with respect to the vehicle's direction of travel, the bottom, designated at 3d, is so formed that the front bottom is deeper than the rear bottom, whereby the helmets 5 stored in storage box 3 are put with their front side 5c inclined forward and downwards. Therefore, it is possible to reduce the seat width and hence prevent part of storage box 3 at its maximum width from interfering with the seat position of the rider or extra rider. Moreover, it is possible to secure a large opening and a large storage volume.

According to the second embodiment, upper opening 3a of storage box 3 is formed so that the distance X from the approximate center to opening edge 3b on the first side is greater than the distance Y to the opening edge 3c on the other side and opening edge 3b is positioned to be approximately equal to the maximum width of storage box 3 from the center while the opening edge 3b is formed on the side opposite to kickstand 30 provided on one side of the vehicle. Further, the opening is formed so that opening edges 3b and 3c of the storage box 3 are adapted to be set approximately horizontal when the motorcycle is parked in a position tilted to one side with kickstand 30 set down. Therefore, this configuration makes it possible, with only minor changes, to provide a low-cost, high-functionality storage box which is improved in storage capacity of small items such as golf balls when the motorcycle is parked on the kickstand.

Further, according to the second embodiment, part of opening edge 3b of upper opening 3a of storage box 3 is shaped in a bay-like form so as to be sunken lower than the height of opening edge 3c on the opposite side while seat bottom plate extension 25a opposing the opening edge 3b is extensionally formed along the outer periphery of seat bottom plate 25 and projected downwards from the outer periphery, spreading outwardly toward its distal side. Therefore, it is possible to secure an opening wider than that of the conventional storage box even if seat 2 is small in width. Thereby, it is possible to provide a storage box 3 which has a large storage volume and makes it easy to put things in and take them out.

According to the second embodiment, since sealing surface 25b as well as the seat bottom plate extension 25a is integrally and continuously formed from seat bottom plate 25, it is possible to improve the dimensional accuracy when parts are manufactured. Therefore, it is easy to secure the necessary sealability even if sealing surface 25b is defined by a complex curved surface, hence this configuration is effective in preventing dirt, rain water and the like from entering the storage box.

According to the second embodiment, since the curved shaped of storage box 3 is such that it maximally swells sidewards of the vehicle, at the portions, in its approximate center when viewed from top with respect to the vehicle's front-to-rear direction, and opposing the tops 5b of helmets 5 and that extra rider 41 riding astride above the storage box 3 is seated with their ankles 41a positioned at the front side of helmets 5, it is possible to secure the easiness in straddling and yet assure the necessary volume of the storage box.

According to the second embodiment, since cover 43 is arranged so as to externally enclose the upper part of storage box 3 having sealing element 42 disposed thereon and seat bottom plate extension 25a, it is possible to reduce the height of the portion below the apparent edge of seat 2 compared to the conventional configuration, hence increase the outline design flexibility.

According to the second embodiment, since helmets 5 are placed in storage box 3 so that they are inclined forwards and downwards with respect to the vehicle body, they can be snugly fitted to a lower position along the inclined side walls of storage box 3. Therefore, it is possible to prevent helmets 5 and other stored things from being shaken casually inside storage box 3 due to impacts from the road surface and the vehicle body being banked during riding. Further, since storage box 3 is laid out over rear wheel 22, storage box 3 can be arranged at a lower position avoiding the rotational locus of rear wheel 2. Therefore, it is possible to reduce the height of seat 2 arranged thereabove.

Next, variational examples of the second embodiment will be shown.

In the first variational example of a storage box for a motorcycle, no matter which side the kickstand is disposed in a motorcycle, the sealing structure of the opening edge of the upper opening of the storage box, on one of the sides with respect to the vehicle's central axis along the vehicle's direction of travel is formed by a conventional typical sealing arrangement in which the seat bottom plate end forms an apparent seat end and the seat bottom plate surface is adapted to seal the storage box; the sealing structure on the other side is constructed such that seat bottom plate extension 25a opposing the opening edge 3b is extensionally formed along the outer periphery of seat bottom plate 25 and projected downwards from the outer periphery, spreading outwardly toward its distal side to thereby seal the seat bottom plate extension. In this configuration, the seal structure cover is needed for one side only, so that a more cost reduction can be obtained.

In the second variational example of a storage box for a motorcycle wherein the seat width is smaller than the width of the upper opening of the storage box formed under the seat and the seat has a cover, the sealing structure of the storage box is formed by a conventional typical sealing arrangement in which the seat bottom plate end forms an apparent seat end on one side with respect to the vehicle's central axis along the vehicle's direction of travel and the seat bottom plate surface is adapted to seal the storage box, and a cover is arranged on only the other side with respect to the vehicle's central axis. In this configuration, as in the first variational example, the seal structure cover is needed for one side only, so that a more cost reduction can be obtained.

It is to be understood that the present invention is not limited to the above embodiments and variational examples illustrated with the accompanying drawings, but various changes and modifications can be added without departing from the scope of the invention.

As has been described heretofore, according to the motorcycle of the present invention, it is possible to markedly enlarge the opening and volume of the storage box formed under the seat and achieve a high enough sealability inside the storage box, by a simple configuration without enlarging the seat shape in its width.

Detailedly, the seat bottom plate is formed integrally with a seat bottom plate extension which is extensionally formed along the outer periphery and projected from the outer periphery, spreading outwardly toward its distal side while a sealing element is disposed between the upper opening brim of the storage box and the seat bottom plate extension. This configuration makes possible provision of sealing surface outside the seat bottom plate side wall and makes it possible to design the opening of the storage box provided under the seat without any restriction of the outline of the seat. Further, it is possible to provide an opening wider than that of the conventional storage box even if the seat is small in width, and it is also possible to provide a storage box which has a large storage volume and makes it easy to put things in and take them out. In one word, this configuration is effective in providing easiness in straddling while securing the volume of the storage box.

According to the luggage storing compartment of the storage box of the present invention, it is possible to secure a large opening and storage volume of the storage box without enlarging the seat width. Further, it is possible to improve the storage capacity of small items such as golf balls or the like when the motorcycle is parked on the kickstand and still provide an arrangement of low-cost luggage storing compartment for a motorcycle.

Detailedly, the luggage storing compartment of a motorcycle is formed such that, in the sectional configuration cut along the vehicle's width, it spreads outwardly as it extends downwards from the opening edge of the upper opening, along the body cover which encloses the outer vehicle body below the seat. That is, the luggage storing compartment is formed so that its middle or lower part with respect to the height is wider than its upper part and part of the opening edge of the upper opening, on a first side with respect to the body width is shaped in a bay-like form so as to be sunken lower than the height of the opening edge on the opposite side. This arrangement contributes to improvement in easiness in riding on and getting off the seat arranged thereover and also provides a large opening width, which makes it easy to put things in and take them out.

Further, the upper opening is formed so that the distance from the approximate center of the luggage storing compartment to the opening edge on a first side with respect to the vehicle's width is greater than the distance to the opening edge on the other side and the opening edge on the first side is positioned so that the opening width is approximately equal to the maximum width of luggage storing compartment. This arrangement makes it easier to put things in and take them out. Further, by arranging the opening edge on the first side, on the side opposite to the kickstand provided on the other side of the vehicle, it is possible to increase the effective depth of the luggage storing compartment when the motorcycle is inclined to the kickstand side with the kickstand set down or in the state where luggage is loaded. Moreover, since the opening is formed so that the opening edges of the luggage storing compartment are adapted to be set approximately horizontal when the motorcycle is parked in a position tilted to one side with the kickstand set down, the effective depth of the luggage storing compartment is gained when the motorcycle is parked on the kickstand.

Finally, the seat comprises a seat bottom plate having a side wall which is extensionally formed at sides with respect to the vehicle's width, spreading outwardly as it extends downwards. The luggage storing compartment is constructed such that the opening edge on one side with respect to the vehicle's width is adapted to abut the bottom wall of the seat bottom plate and abut the lower end of the seat bottom plate side-wall while the opening edge on the other side is made to abut the bottom wall of the seat bottom plate. This arrangement makes it possible to secure a large difference in height between the left and right opening edges, and is effective in dealing with the large tilt angle of the motorcycle when it is parked on the kickstand.

What is claimed is:

1. A motorcycle comprising: a seat which can be opened upward and closed; a storage box whose upper opening is opened and closed by the seat and which is able to hold helmets, the surround of the storage box is covered by the body cover, characterized in that
the seat is comprised of a seat bottom plate, a seat cushion for covering the top of the seat bottom plate and a seat cloth for covering the surface of the seat cushion;
the seat bottom plate is integrally formed with a seat bottom plate extension which is extensionally formed along the outer periphery, spreading outwardly toward its distal side;
a sealing element is disposed between the upper opening brim of the storage box and the seat bottom plate extension; and
a cover is arranged over the outer peripheral surface of the seat bottom plate extension so as to externally enclose the upper part of the storage box having the sealing element disposed thereon and the seat bottom plate extension.

2. The motorcycle according to claim 1, wherein the seat is integrally formed with a rib-like structure, projected outwards from the seat bottom plate and disposed along the outer periphery of the seat cushion around the seat bottom plate extension and the rib-like structure together with the seat cushion is covered by the seat cloth with the distal part of the seat cloth fixed by fasteners.

3. The motorcycle according to claim 1, wherein the storage box has a volume capable of storing at least two helmets and is shaped into a storage compartment which can keep the two helmets placed side by side across the vehicle's width with their spherical tops set laterally outward with respect to the body width, their lower sides abutted to each other, and their front set forwards with respect to the vehicle's direction of travel and has an inner shape congruent with the outer shapes of the helmets thus arranged.

4. The motorcycle according to claim 2, wherein the storage box has a volume capable of storing at least two helmets and is shaped into a storage compartment which can keep the two helmets placed side by side across the vehicle's width with their spherical tops set laterally outward with respect to the body width, their lower sides abutted to each other, and their front set forwards with respect to the vehicle's direction of travel and has an inner shape congruent with the outer shapes of the helmets thus arranged.

5. The motorcycle according to claim 1, wherein the storage box is constructed in such a manner that the bottom surface is formed to be lower at both sides than at the center across the body width so that two helmets can be held side by side across the body width with their spherical tops inclined downwards and laterally outward with respect to the body width.

6. The motorcycle according to claim 2, wherein the storage box is constructed in such a manner that the bottom surface is formed to be lower at both sides than at the center across the body width so that two helmets can be held side by side across the body width with their spherical tops inclined downwards and laterally outward with respect to the body width.

7. The motorcycle according to claim 3, wherein the storage box is constructed in such a manner that the bottom surface is formed to be lower at both sides than at the center across the body width so that two helmets can be held side by side across the body width with their spherical tops inclined downwards and laterally outward with respect to the body width.

8. The motorcycle according to claim 4, wherein the storage box is constructed in such a manner that the bottom surf ace is formed to be lower at both sides than at the center across the body width so that two helmets can be held side by side across the body width with their spherical tops inclined downwards and laterally outward with respect to the body width.

9. A storage box arrangement for use in a motorcycle comprising: a seat which can be opened upward and closed; a storage box whose upper opening is opened and closed by the seat and which is able to hold helmets, the surround of the storage box is enclosed by the body cover, characterized in that, in the sectional configuration cut across the vehicle's width, the storage box is shaped so that it spreads outwardly as it extends downwards from the opening edge of the upper opening, along the body cover which encloses the outer vehicle body below the seat while part of the opening edge of the upper opening on a first side with respect to the body width is shaped in a bay-like form so as to be sunken lower than the height of the opening edge on the opposite side.

10. The storage box arrangement for use in a motorcycle according to claim 9, wherein the storage box is constructed so that the distance from the approximate center of the luggage compartment to the opening edge on the first side is greater than the distance to the opening edge on the opposite side and the opening edge on the first side with respect to the vehicle width is positioned so that the opening width is approximately equal to the maximum width of the luggage storing compartment.

11. The storage box arrangement for use in a motorcycle according to claim 9, wherein the storage box is constructed so that the opening edge on the first side is formed on the side opposite to a kickstand which is arranged on one side with respect to vehicle's width.

12. The storage box arrangement for use in a motorcycle according to claim 10, wherein the storage box is constructed so that the opening edge on the first side is formed on the side opposite to a kickstand which is arranged on one side with respect to vehicle's width.

13. The storage box arrangement for use in a motorcycle according to claim 11, wherein the storage box is constructed so that the opening edges on both sides are adapted to be set approximately horizontal when the motorcycle is parked in a position tilted to one side with the kickstand set down.

14. The storage box arrangement for use in a motorcycle according to claim 12, wherein the storage box is constructed so that the opening edges on both sides are adapted to be set approximately horizontal when the motorcycle is parked in a position tilted to one side with the kickstand set down.

15. The storage box arrangement for use in a motorcycle according to claim 9, wherein the seat comprises a seat bottom plate having a side wall which is extensionally formed at sides with respect to the vehicle's width, spreading outwardly as it extends downwards, and the storage box is constructed such that the opening edge on the first side with respect to the vehicle's width is adapted to abut the bottom wall of the seat bottom plate and abut the lower end of the seat bottom plate side-wall while the opening edge on the other side is made to abut the bottom wall of the seat bottom plate.

16. The storage box arrangement for use in a motorcycle according to claim 10, wherein the seat which can be opened upward and closed comprises a seat bottom plate having a side wall which is extensionally formed at sides with respect to the vehicle's width, spreading outwardly as it extends downwards, and the storage box is constructed such that the opening edge on the first side with respect to the vehicle's width is adapted to abut the bottom wall of the seat bottom plate and abut the lower end of the seat bottom plate side-wall while the opening edge on the other side is made to abut the bottom wall of the seat bottom plate.
